(19) United States
(12) Patent Application Publication
(10) Pub. No.: US 2006/0121763 A1
(43) Pub. Date: Jun. 8, 2006

(54) [COMBINATION OF BURN-IN SOCKET AND ADAPTER BORAD]

(75) Inventors: YUNG-LIANG CHIANG, TAIPEI (TW); Kuo-Feng Chen, (US)

Correspondence Address: SPEED MASTER TECHNOLOGY CO., LTD., P.O. BOX 108-00403, TAIPEI, TW

(73) Assignee: SPEED MASTER TECHNOLOGY CO., LTD., HSINTIEN CITY (TW)

(21) Appl. No.: 10/904,925

(22) Filed: Dec. 6, 2004

(51) Int. Cl. H01R 13/62

(52) U.S. Cl. 439/331

(57) ABSTRACT

A combination of burn-in socket and adapter board includes a burn-in socket and an adapter board for connecting the burn-in socket to a test apparatus, the burn-in socket having a body, a shell accommodating the body and defining a receiving hole for receiving a test sample (electronic element) for test, and terminals installed in the body, each terminal having a contact portion suspending in the receiving hole of the shell for the contact of the inserted test sample (electronic element) and a mounting portion extended out of the bottom side of the body and connected to a respective contact at the adapter board.

### BACKGROUND OF THE INVENTION

1. Field of the Invention

The present invention relates to carrier means for holding an electronic element for burn-in test and more particularly, to a combination of burn-in socket and adapter board that prevents deformation of terminals during installation.

2. Description of the Related Art

Following fast development of high technology, electronic devices are designed in the trend of light, think, short and small styles. After fabrication, electronic elements may have to receive burn-in test, examining their life cycle under an environment of high temperature, high voltage and high current. Inferior electronic elements that do not pass the test are swept out.

During burn-in test, a burn-in socket is used to hold the test sample and to electrically connect the test sample to a test apparatus for test. However, because different test samples (memory devices, logic products, sockets) have different contact pin patterns, different burn-in sockets shall be prepared for holding different test samples, thereby resulting in high test cost. The terminals of conventional burn-in sockets are made of resilient metal material or have a respective spring member fixedly connected thereto for positive connection to respective contacts at an adapter board that is used to connect the burn-in socket to a test apparatus. Therefore, changing a burn-in socket subject to the type of the test samples to test is complicated. Further, following the trend of micromization, nanotechnology has been employed to the fabrication of IC chips, and related burn-in sockets are micromized. When connecting the terminals of a micromized burn-in sockets to a test apparatus, the terminals may be deformed or inserted into wrong contact holes accidentally, and a short circuit may occur when turned on the test apparatus, thereby causing the test sample to be burned out.

### SUMMARY OF THE INVENTION

The present invention has been accomplished under the circumstances in view. According to one aspect of the present invention, the combination of burn-in socket and adapter board comprises a burn-in socket having terminals for the contact of the inserted test sample (electronic element) to test, and an adapter board for connecting the burn-in socket to the test apparatus. The adapter board has contacts for the contact of the terminals, and bottom contact pins for connection to the test apparatus electrically. By means of the adapter board, the burn-in socket can conveniently be connected to the test apparatus without deforming the terminals. According to another aspect of the present invention, the burn-in socket comprises a body holding the terminals, and a shell detachably fastened to the body with locating pins that are detachably mounted in respective mounting through holes in the shell and inserted into respective mounting holes in the body. The shell has a receiving hole for holding a test sample (electronic element) in contact with the terminals for test. Therefore, the user can change the shell subject to the type of the test sample (electronic element) to test. According to another aspect of the present invention, a number of adapter boards may be installed in a breadboard to carry a respective burn-in socket so that a number of test samples can be tested at a time.

### BRIEF DESCRIPTION OF THE DRAWINGS

FIG. 1 is an exploded view of a combination of burn-in socket and adapter board according to the present invention.

FIG. 2 is an elevational view of the combination of burn-in socket and adapter board after removal of the cover from the burn-in socket according to the present invention.

FIG. 3 is a side view in section in an enlarged scale of the combination of burn-in socket and adapter board shown in FIG. 2.

FIG. 4 is an elevational view of the combination of burn-in socket and adapter board according to the present invention.

FIG. 5 is a side view in section in an enlarged scale of FIG. 4.

FIG. 6 is a sectional side view of an alternate form of the combination of burn-in socket and adapter board according to the present invention.

FIG. 7 is an elevational view of the alternate form of the combination of burn-in socket and adapter board according to the present invention.

FIG. 8 is an application example of the present invention, showing multiple burn-in sockets respectively installed in respective adapter boards at a bread board according to the present invention.

### DETAILED DESCRIPTION OF THE PREFERRED EMBODIMENT

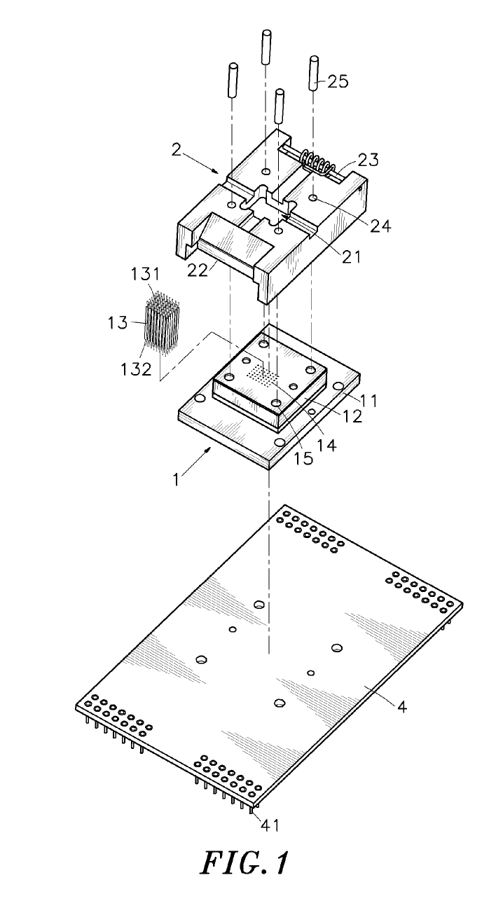

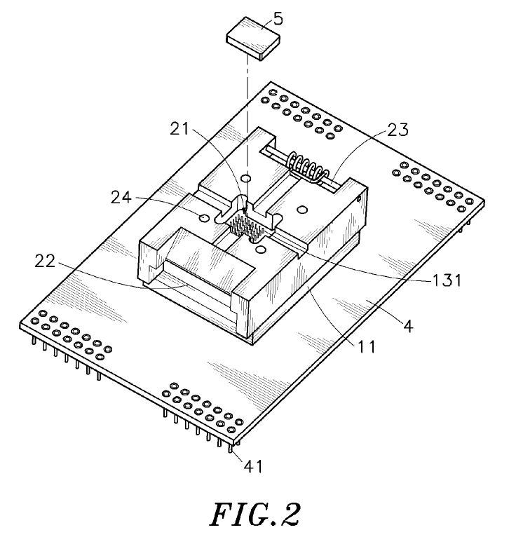

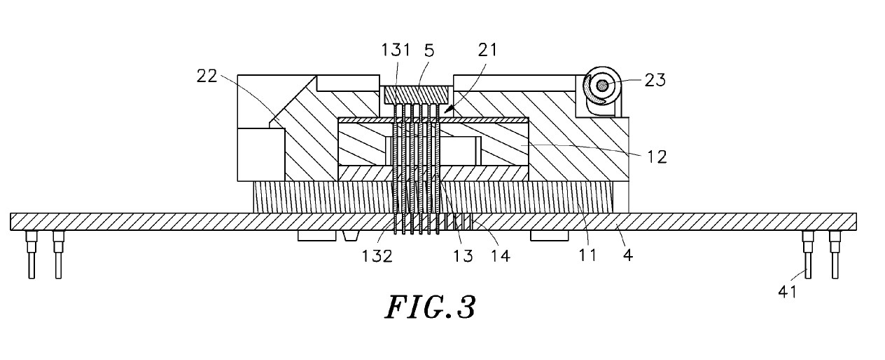

Referring to FIGS. 1-3, a burn-in socket is shown comprising a body 1, and a shell 2.

The body 1 comprises a base 11, a locating block 12 provided at the top of the base 11, a plurality of terminal slots 14 vertically extended through the locating block 12 and the base 11, and a plurality of mounting holes 15 formed in the locating block 12. Further, terminals 13 are respectively mounted in the terminal slots 14, each having a contact portion 131 at one end and a mounting portion 132 at the other end.

The shell 2 accommodates the body 1, comprising a receiving hole 21 adapted to receive a test sample (electronic element) 5, a fixed hook 22 provided at one side, a pivot axle 23 transversely provided at the other side opposite to the fixed hook 22, and a plurality of mounting through holes 24 respectively connected to the mounting holes 15 of the body 1 with locating pins 25.

After installation of the terminals 13 in the terminal slots 14 of the body 1, the contact portions 131 and mounting portions 132 of the terminals 13 respectively protrude over the top side of the locating block 12 and the bottom side of the base 11. The mounting portions 132 of the terminals 13 can be fastened to respective contacts (contact holes) of an adapter board 4, which has a plurality of bottom contact pins 41 for connection to a test apparatus (not shown). By means of the adapter board 4, the terminals 13 connect the test sample (electronic element) 5 to the test apparatus for test. Because the terminals 13 are not inserted in and out of the test apparatus, connecting the burn-in socket to the test apparatus does not cause the terminals 13 to deform.

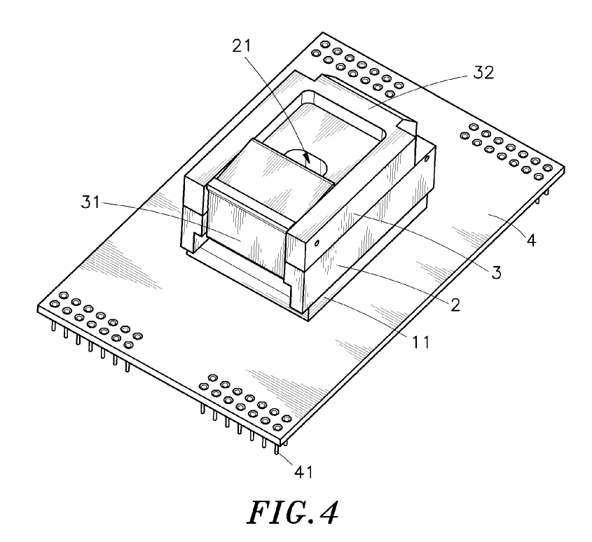

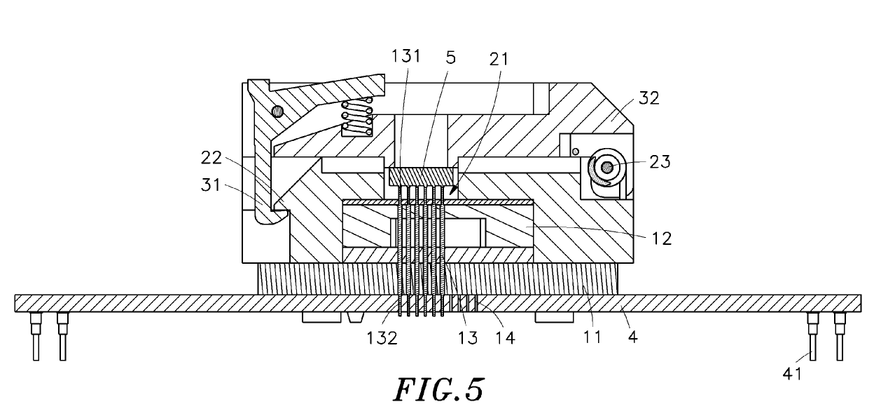

Referring to FIGS. 4 and 5, the shell 2 is provided with a cover 3. The cover 3 comprises a knuckle 32 transversely provided at one end and pivotally coupled to the pivot axle 23 of the shell 2, and a spring-supported hook 31 pivotally provided at the other end remote from the knuckle 32 for hooking the hook 22 of the shell 2. When closed the cover 3 on the shell 2, the spring-supported hook 31 is hooked up with the hook 22 of the shell 2 to hold the cover 3 in the close position. When disengaging the spring-supported hook 31 from the hook 22 of the shell 2, the cover 3 can be tuned about the pivot axle 23 from the close position to an open position. After insertion of the test sample (electronic element) 5 into the receiving hole 21 of the shell 2, the cover 3 is closed to hold the test sample (electronic element) 5 in position, keeping the respective contacts of the test sample (electronic element) 5 in contact with the contact portions 131 of the terminals 13 for burn-in test.

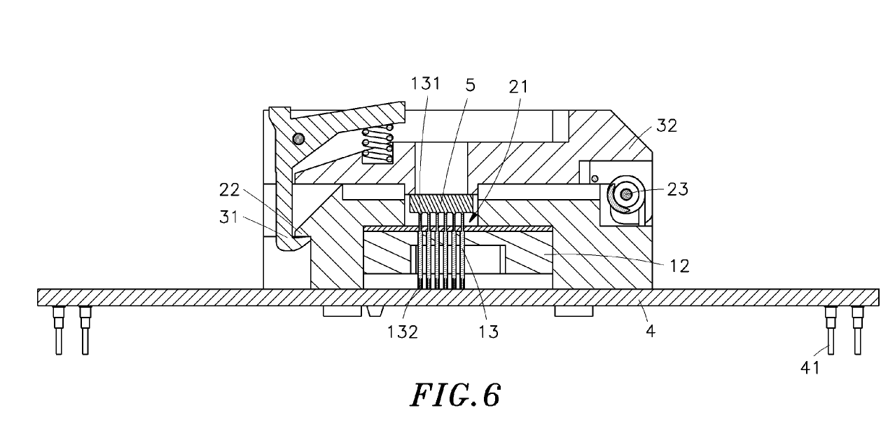

Referring to FIG. 6, the terminals 13 can be respectively formed of a metal coil spring. Alternatively, the mounting portions 132 of the terminals 13 can be respectively formed of a metal spring member. When installed, the mounting portion 132 of each terminal 13 is compressed and maintained in contact with the respective contact at the top side of the adapter board 4 positively.

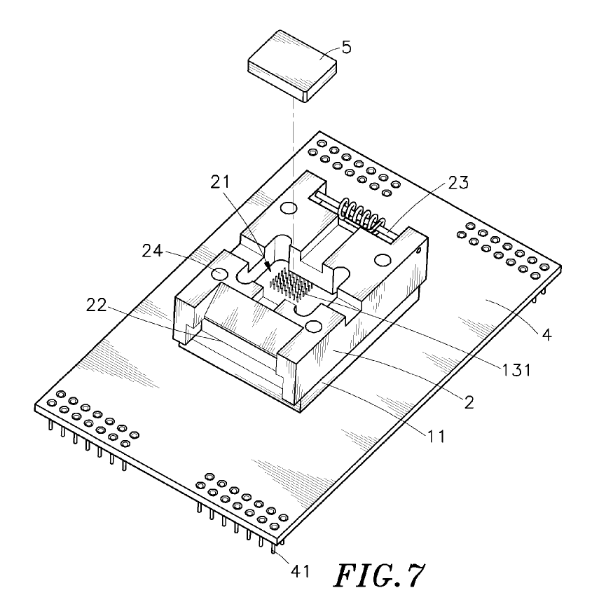

Referring to FIG. 7, the receiving hole 21 of the shell 2 is specifically made to receive a particular test sample (electronic element) 5. The locating pins 25 are detachably mounted in the mounting through holes 24 of the shell 2 and the mounting holes 15 of the body 1 to secure the shell 2 to the body 1. Therefore, the shell 2 can conveniently be detached from the body 1 for a replacement. For testing a different type of test sample (electronic element) 5, a different shell 2 shall be used.

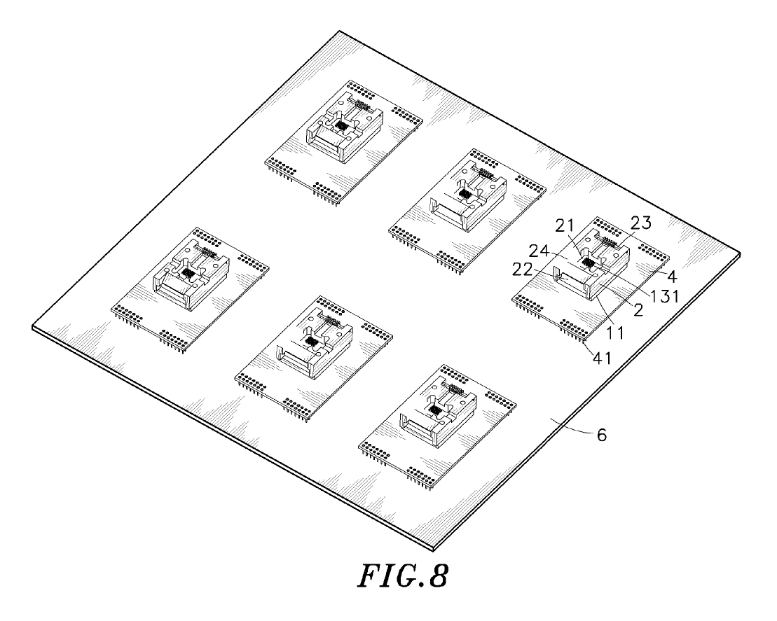

FIG. 8 shows an application example of the present invention. As illustrated, adapter boards 4 are installed in a breadboard 6 to hold a respective burn-in socket. After installation of test samples (electronic element) 5 in the burn-in sockets at the adapter boards 4, the breadboard 6 is electrically connected to the test apparatus, and the user can then control the test apparatus to test the inserted test samples at a time.

A prototype of burn-in socket and adapter board arrangement has been constructed with the features of FIGS. 1-8. The burn-in socket and adapter board arrangement functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A combination of burn-in socket and adapter board comprising a burn-in socket and an adapter board for connecting said burn-in socket to a test apparatus, said burn-in socket comprising a body, a shell accommodating said body, said shell having a receiving hole adapted to receive a test sample (electronic element) for test, and a plurality of terminals installed in said body, said terminals each having a contact portion and a mounting portion respectively disposed at two distal ends thereof,
wherein said terminals are respectively inserted through said body of said burn-in socket, keeping the respective mounting portions extended out of a bottom side of said body and connected to respective contact at said adapter board; said adapter board comprises a plurality of bottom contact pins for connection to respective contacts of a test apparatus to electrically connect said terminals to the test apparatus.

2. The combination of burn-in socket and adapter board as claimed in claim 1, wherein said body of said burn-in socket comprises a base, a locating block provided at a top side of said base, and a plurality of terminal slots vertically extended through said base and said locating blocks for holding said terminals.

3. The combination of burn-in socket and adapter board as claimed in claim 1, wherein said terminals are respectively mounted in said terminal slots in said body, keeping the respective contact portions suspended in said receiving hole of said shell for the contact of the test sample (electronic element) to test and the respective mounting portions electrically connected to said adapter board.

4. The combination of burn-in socket and adapter board as claimed in claim 1, wherein said terminals are respectively formed of a resilient metal material.

5. The combination of burn-in socket and adapter board as claimed in claim 1, wherein said mounting portion of each said terminal is formed of a metal spring member.

6. The combination of burn-in socket and adapter board as claimed in claim 1, wherein said locating block of said body has a plurality of mounting holes; said shell has a plurality of mounting through holes and a plurality of locating pins respectively mounted in said mounting through holes and detachably inserted into the mounting holes of said locating block to detachably secure said shell to said body.

7. The combination of burn-in socket and adapter board as claimed in claim 1, wherein said burn-in socket further comprises a cover adapted to close said receiving hole of said shell.

8. The combination of burn-in socket and adapter board as claimed in claim 6, wherein said shell further comprises a fixed hook provided at a first side thereof, and a pivot axle transversely provided at a second side thereof opposite to said first side; said cover comprises knuckle means transversely provided at a first end thereof and pivotally coupled to said pivot axle and a spring-supported hook pivotally provided at a second end thereof for hooking said fixed hook of said shell.
